(19) United States
(12) Patent Application Publication
(10) Pub. No.: US 2019/0236979 A1
(43) Pub. Date: Aug. 1, 2019

(54) SYSTEMS, APPARATUSES, AND METHODS FOR LANGUAGE INSTRUCTION

(71) Applicant: Haiyan Fan, Flower Mound, TX (US)

(72) Inventor: Haiyan Fan, Flower Mound, TX (US)

(21) Appl. No.: 16/260,022

(22) Filed: Jan. 28, 2019

Related U.S. Application Data
(60) Provisional application No. 62/622,237, filed on Jan. 26, 2018.

(51) Int. Cl. G09B 19/06; G09B 5/02

(52) U.S. Cl. CPC G09B 19/06; G09B 5/02

(57) ABSTRACT

A non-transitory computer readable medium having program instructions stored thereon for causing a computer to perform a method of language instruction or the method being used for the teaching for language acquisition by a user, is disclosed. The method includes accessing a database having a representation of a Chinese character and a morphological decomposition of the Chinese character for the purpose of language acquisition by a user, stored thereon. The method also includes accessing the database having stored thereon an etymological associations of the Chinese character with an oracle bone script symbol. Further, the method includes presenting to the user a representation of the Chinese character and how the Chinese character morphologically and etymologically relates to the oracle bone script symbol. Further still, the method relates to presenting to the user the morphological decomposition of the Chinese character.

### REFERENCE TO RELATED APPLICATIONS

This application claims priority to U.S. Provisional Patent Application No. 62/622,237, filed on Jan. 26, 2018 to inventor Haiyan Fan, entitled SYSTEMS, APPARATUSES, AND METHODS FOR LANGUAGE INSTRUCTION, which is herein incorporated by reference in its entirety.

### BACKGROUND

Learning a foreign language is often times a painful and ineffective experience for many people. It is particularly so when it comes to learn Chinese, a pictograph language, which is completely foreign to westerns who are familiar with alphabet language. The market is full of curriculum with the traditional audio-lingua approach, designed to teach alphabet language such as English and Spanish.

These teaching materials are ineffective in three folds. First, there is little or no attention regarding the linguistic nature of the target language. Second, there is little or no attention regarding learners' curiosity, and innate capacity to learn in an environment transformed by technology and multi-media consumptions. Third, traditional learning methods delivered through textbook and mass class are not suitable for personalized learning.

### SUMMARY

An exemplary embodiment relates to a non-transitory computer readable medium having program instructions stored thereon for causing a computer to perform a method of language instruction or the method being used for the teaching for language acquisition by a user. The method includes accessing a database having a representation of a Chinese character and a morphological decomposition of the Chinese character for the purpose of language acquisition by a user, stored thereon. The method also includes accessing the database having stored thereon an etymological associations of the Chinese character with an oracle bone script symbol. Further, the method includes presenting to the user a representation of the Chinese character and how the Chinese character morphologically and etymologically relates to the oracle bone script symbol. Further still, the method relates to presenting to the user the morphological decomposition of the Chinese character.

Another exemplary embodiment relates to a non-transitory computer readable medium having program instructions stored thereon for causing a computer to perform a method. The method includes accessing a database having a representation of a Chinese character to be learned by a user, stored thereon and accessing associations of the Chinese character with an oracle bone script symbol. The method also includes presenting learning information related to the Chinese character to a user and testing a user about their knowledge of the Chinese character. Further, the method includes storing a representation of the user's learning progress based on the knowledge of the Chinese character and accessing the representation of the user's learning progress. Further still, the method includes providing recommendations of what the user should learn next based on the user's learning progress.

Yet another exemplary embodiment relates to a non-transitory computer readable medium having program instructions stored thereon for causing a computer to perform a method. The method includes generating a list of Chinese characters to be learned for a user, having a user profile stored on a server computer, the generating of the list based on a set of parameters associated with the user profile, the list of Chinese characters being chosen from a database of Chinese characters. The method also includes transmitting by a server computer morphological decompositions and beacons of the Chinese characters from the list of Chinese characters. Further, the method includes determining the user's progress of learning the Chinese characters and receiving by the server computer an indication of the user's progress of learning of the Chinese characters. Further still, the method includes updating the set of parameters associated with the user profile based on the indication of the user's progress of learning the Chinese characters.

It should be appreciated that all combinations of the foregoing disclosures and additional disclosures discussed in greater detail below (provided such disclosure are not mutually inconsistent) are contemplated as being part of the inventive subject matter disclosed herein. In particular, all combinations of claimed subject matter appearing at the end of this application are contemplated as being part of the inventive subject matter disclosed herein. It should also be appreciated that terminology explicitly employed herein that also may appear in any disclosure incorporated by reference should be accorded a meaning most consistent with the particular disclosure described herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates character tagging, according to some embodiments of the disclosure.

FIG. 2 illustrates a method of parsing characters and building database, according to some embodiments of the disclosure.

FIG. 3 shows a schematic to illustrate the three types of characters, including Oracle Bone Script (OBS) characters, Low Hanging Fruit (LHF) characters, and Unlocked (UL) characters, according to some embodiments of the disclosure.

FIGS. 4A-4C show graphical illustration of an OBS character, an LHF character, and its derived UL character, respectively, according to some embodiments of the disclosure.

FIG. 5 illustrates study sets created for language learning, according to some embodiments of the disclosure.

FIG. 6 illustrates a method of sheet and column assignment for a given character, according to some embodiments of the disclosure.

FIG. 7 illustrates a method of row assignment for a given character, according to some embodiments of the disclosure.

FIG. 8 illustrates an example of row assignment, according to some embodiments of the disclosure.

FIG. 9 illustrates a method of beaconizing an OBS character, according to some embodiments of the disclosure.

FIG. 10 illustrates a method of beaconizing an OBS phrase, according to some embodiments of the disclosure.

FIGS. 11 and 12 show examples of LHF character beaconization, and UL character beaconization, respectively, according to some embodiments of the disclosure.

FIG. 13 shows a schematic of a platform to facilitate language learning and teaching according to some embodiments of the disclosure.

FIG. 14 shows an example of a personalized study set generator.

FIG.15 shows an example of a recommendation generator.

### DETAILED DESCRIPTION

Systems, apparatus, and methods described above can be used for personalized online learning and teaching of the Chinese language. More specifically, this personalized learning and teaching can include dynamically adapting Chinese character study sets in the form of games to accommodate each individual learner's prior knowledge and ability. New study sets are built based on the linguistic beacons of the previous study sets so as to maximize the strength of the linguistic signals in the learners' memory.

As described herein, learning a foreign language is often a painful and ineffective experience for many people because of hard memorization. It is particularly so when it comes to learn Chinese, a pictograph language in which the written form (morphology) of the character conveys the meaning (semantics) of the character. Such morphology-semantics signaling is completely foreign to westerners who are used to morphology-phonology signaling, in which the alphabetic spelling (morphology) coveys the sound (phonology) of the word.

Traditional language learning materials such as Rosetta Stone Chinese are typically structured according to communicative scenes, such as greeting, food ordering, and asking for directions, among others. Such pragmatics signaling methods impose significant challenges onto the learners as the characters that make up the conversation drills can be unrelated in the above-mentioned three basic linguistic signals: morphology, phonology, and semantics. Hence foreign language learners may instead resort to hard memorization, notorious for memory attrition and low retention.

In addition, regular language learning textbooks are usually published and delivered to the hands of the learners following a centralized editor-centered process. Very limited linguistic materials and supporting learning materials, such as photo and images vividly depicting the target learning point, are presented to the learners in the limited space of textbooks. Learners often suffer from monotonous repetition and boredom.

Furthermore, in a traditional classroom, the teacher usually broadcasts the same material at the same pace to a group of individual learners. These learners may have diversified learning abilities and areas of interests, resulting in learning inefficiency and low motivation.

Systems, apparatus and methods described herein address these challenges in several aspects. One aspect helps Chinese language learners establish morphology-semantics signaling as it is the most direct and strong signaling path given the nature of the Chinese language. Such morphology-semantics signals can be progressively stored as beacons in learners' memory to allow efficient, networked memorization to take place. Another aspect includes a personalized learning system to “meet the learners where they are” in terms of their linguistic ability, their current memory level of the learned materials, as well as their personal areas of interest. A third aspect includes a decentralized process for distributing the language learning materials. Learners can have access to a myriad of linguistic learning materials with illustrative images contributed from a community of users sharing the same interest. Rich linguistic materials can make repetition of the learned material with great variety such that repetition, which is necessary for memorization, becomes not mechanical but meaningful and interesting.

Some embodiments of the present disclosure can include one or more of the following features: 1) a beaconization methods that progressively build Chinese morphology-semantics beacons, which in turn can help learners efficiently learn Chinese characters and their associated phrases; 2) a game-based Chinese language system that dynamically adapts to the learners' current memory level of learned materials and their own preference for learning pace; 3) a technology platform that allows thousands of users in the community to contribute linguistic learning materials with illustrative images to be shared by all learners; and 4) a computer implemented method that allows users to provide evaluation of the user-generated content so that high quality ones are rewarded with high ranking and visibility.

In some embodiments, a multimedia platform is provided built on a database of linked Chinese characters, phrases, singles, radical, compounds, and morphology-semantics beacons. One part of the platform is configured to curate related multi-media content such as sound bite, pictures, GIF images, and short video clips, among others. These content is specifically pertaining to the key learning point. Another part of the platform is configured to log all user learning data, specific to each and every target learning point. From the database of beaconized Chinese characters and phrases, study sets and the embedded games are generated for each individual user's account. There can be at least two types of study sets: editor generated study sets and user generated study sets. In one example, these study sets can be created and stored in advance. In another example, these study sets can be created in real time as any individual user is uploading them to the system. Collaborative filtering techniques can be used to maintain good quality of the study sets.

Advantages of systems, apparatuses, and methods, according to at least some embodiments described herein, can provide several benefits. For example, they provide a cognitive efficient method to learn Chinese characters and their associated phrases. In addition, they provide a method for beaconizing Chinese characters and phrases for all learners of Chinese as a foreign language. The personalized learning system can adapt to each individual learner's linguistic ability, current memory level of the learned materials, as well as personal areas of interest. The computer implemented system allows user-generated linguistic content to be shared and evaluated by the community of users and further allows learners to have access to study sets generated by other users in the community.

Definitions. The following definition aid in the understanding of at least some of the embodiments of the present disclosure.

Root: a constituent of a character. The root usually corresponds to an original character found in Oracle Bone Script and denotes origin and the semantic lineage of the character.

Radical: a constituent of a character and the short hand for the semantic unit in a compound character.

Body: a component of a Chinese character under which the character is traditionally listed in a Chinese dictionary. In many cases, the body is the smallest sense-making unit of the Chinese characters called “single”.

OBS character (or OBS char): Oracle Bone Script (OBS) characters are the original 300 or so singles and radicals in the Oracle Bone Script (in some cases Jin Script and Zhuan Script) that serve as the basic building block of all modern Chinese language. They are the character roots. All OBS characters are the original pictographs.

LHF character (or LHF char): Low Hanging Fruit (LHF) characters are characters directly derived from the OBS character. They retain a strong morphological or semantic tie to the originating OBS character.

UL character (or UL char): Unlocked (UL) characters are further derived from the originating OBS character and/or LHF character. They are further away from the word root, in most cases, still retaining certain semantic tie to the originating OBS character.

Character type: a given character can be categorized as one of three character types: OBS character, LHF character, or UL character.

Beacon: all character bodies and character radicals have their origins in the oracle bone script that are all pictographs. These character bodies and character radicals become the “beacon” for learning Chinese characters and their English or foreign language translation become part of the beacon carrying English information to the language learners. A beacon consists of two parts: a) a Chinese character component, taking the form of a single character, a compound character, or a body, or a radical, and b) one of its semantic definition in English or a foreign language translation. The process of formulating and encoding the beacon in this method is beaconization.

Tagging: inherent characteristics of a character or phrase and can be used to define a character or phrase. A character can include six tags: morphology, etymology, phonology, semantics, pragmatics, and syntax. The later three tags can be used for phrases.

Morphology: the writing or the appearance of a character.

Etymology: the origin of a character.

Phonology: the sound or pronunciation of a character.

Semantics: the meaning of a character or phrase.

Pragmatics: the usage of the character or phrase in real language context.

Syntax: the grammatical structure of a character or phrase.

Learning progress: a learner's measured and recorded progress of learning the Chinese characters. In some embodiment, it can be number of viewing times the user has viewed a character/phrase presented to him/her. It can also be a test score related to the target character/phrase.

Learner profile: a learner's profile collected via certain computer interface regarding user's personal interest and preferences

Learning goals: a learner's self-selected objective or target related to learning Chinese characters, at least one of them may be 200 sight words (yellow belt level), 500 most frequent characters (orange belt level), etc.

Learning intention: a learner's primary motivation/intention to learn a foreign language, at least one of them may be for daily conversation, or for pass certain test or examination, or for travel and leisure, etc.

Challenge level: a learner's self-specified rating of challenge level measured by a percentage of unlearned characters allowed to appear in any given new presentation of study set.

Systems, Apparatus, and Methods for Language Instruction

Learning Chinese as a foreign language is usually a difficult undertaking for people who are used to the alphabet language system. For example, learning 3,000 Chinese characters is typically a significant hurdle to overcome for learners. A big question in Chinese learning, as well as in Chinese teaching, is to construct a scalable system to make learning 3,000 Chinese characters and associated phrases effective and fun for everyone.

The inventor discovered that the process of Chinese character formation is highly systemic, logical, and orderly. Being the strongest linguistic information piece among all three (sound, writing, meaning) paves the path for sense-making, knowledge association, which is a critical condition for memorization and retention. The disclosure of the present application solves the problem of learning compound characters by digging deep into the etymological roots, and weaving a string of characters of the same etymological roots together, bound by their semantic underpinning. Hence, through meticulously designed sequencing of Chinese characters and linguistic building blocks, the disclosure of the present application makes it possible for learners to “learn one know ten,” or “learn one unlock a vector.”

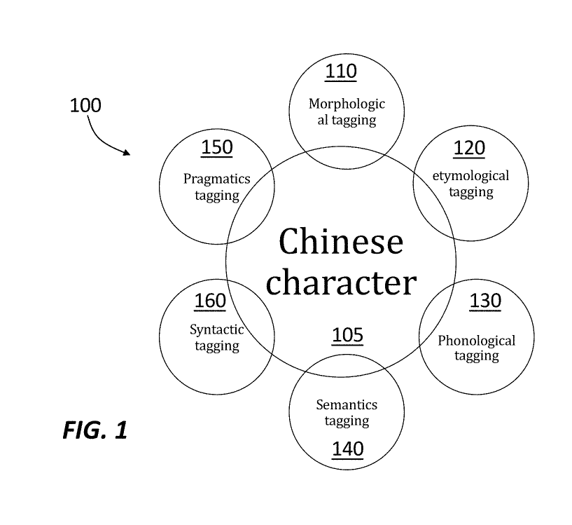

FIG. 1 illustrates an exemplary scheme 100 of character tagging according to some embodiments of the present disclosure. Accordingly, database of about 3,000 most frequently used Chinese characters and their associated phrases, may be provided. Each character 105 in the database is characterized by a set of characteristics 110 to 160 (also referred to as tags 110-160). These tags fall into six main linguistic categories (also referred to as dimensions). Five dimensions are common to all characters in the database, including: morphology 110 (i.e., the writing or appearance of the character), etymology 120 (i.e., the origin of the character), phonology 130 (i.e., the sound or pronunciation of the character), semantics 140 (i.e., the meaning of the character), and pragmatics 150 (i.e., the usage of the character in real language context). The sixth tagging dimension is syntax 160 (i.e., the grammatical structure), pertaining only to syntax indicator characters in the Chinese language.

Morphological tagging 110: Morphological parsing involves identifying and separating the character body (also referred to as the body) and the character radical (also referred to as the radical), in the format of the formula below. In the Chinese language, the body is a graphical component of a Chinese character under which the character is traditionally listed in a Chinese dictionary. In most cases, the body is the smallest sense-making unit of the Chinese characters called “single”. Usually, a single may not be divided further while still carrying meaning. The radical is typically a shorthand of singles, typically representing part of the semantics of the character. All Chinese characters can be formulized or decomposed a format:

Character=body(b0. . . bn)+radical(r0. . . rn), where n=0˜3

Etymological tagging 120: etymological parsing involves identifying the etymological origin of each of the Chinese characters. The Chinese language originated in the late 2nd millennium BCE in the form of Oracle bone script (OBS), which was the form of Chinese characters engraved (or inscribed) on oracle bones, such as animal bones or turtle plastrons used in pyromantic divination. There are about 300 single characters and radicals that are recognized in OBS and are still used in modern Chinese today, forming the basic building block of all modern Chinese characters. Identifying the etymological origin of each character can significantly improve learning efficiency, as it provides a logical thread for the learners to make sense of the character, instead of hard memorization.

Phonological tagging 130: phonological parsing involves identifying the pinyin (Chinese character pronunciation) of each character, as well as separating the vowels and consonants in each pinyin.

Semantics tagging 140: sematic parsing involves identifying the semantic entries of each Chinese character in the English translation (e.g., in a dictionary). In the cases of multiple semantics, beacons of the original semantics will be used to build beacons of the subsequent derivative meaning.

Pragmatics tagging 150: Multiple tags in this dimension can be provided to a given character according to the actual linguistic usage context of the given character. Such linguistic contexts include items such as greetings, emotions, names of family members, traveling, asking for directions, etc.

Syntactic tagging 160: for characters that serve as syntax indicators in the Chinese language, such traits and functions are noted accordingly in the database. For example, [symbol] , a marker for denoting completion of an action is marked accordingly.

Pictograph visualization design: Singles and radicals (e.g., OBS characters) are artfully illustrated, restoring the abstract pictographic symbols to the corresponding real life objects, thus making a strong coupling between “the look” (morphology) and “the meaning” (semantics) of a given single or a radical. Story-rich compound characters are illustrated based on the etymological origin aiming to build a strong semantic tie between the original pictographs and the later derived compound characters.

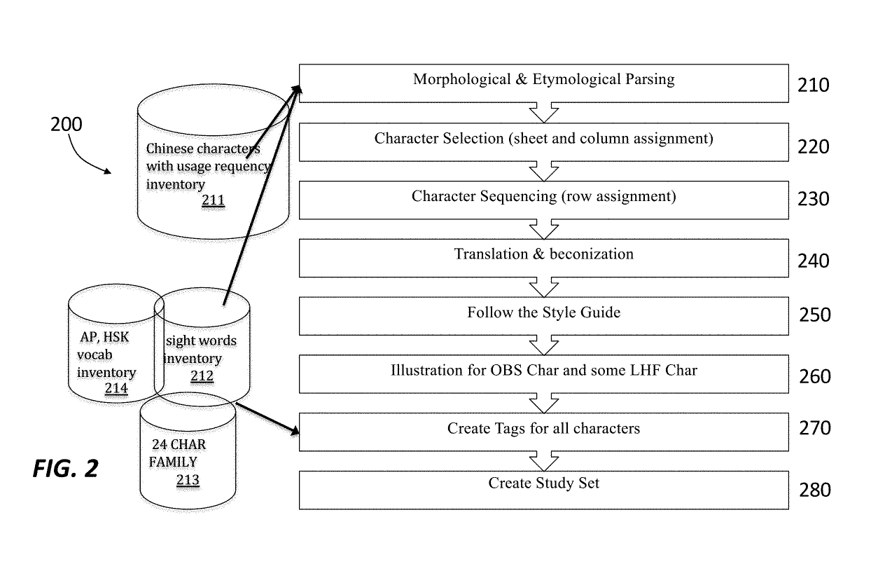

Character belt level: Each character can obtain a belt level code based on its specific location in the database. For example, Low Hanging Fruit (LHF) characters have higher belt levels (according greater belt level codes) than those of OBS characters, and Unlocked (UL) characters have higher belt levels than those of LHF characters. The detailed definition of characters types is provided below with reference to FIG. 2.

FIG. 2 illustrates an exemplary method 200 of parsing characters and building database, according to some embodiments of present disclosure. The method 200 includes, at 210, morphological and etymological parsing of a given character. At this step, each character is selected from two Chinese character inventories 211 and 212 and then parsed to determine the CHAR ROOT (also referred to as the character root), BODY (also referred to as the character body), and RADICAL (also referred to as the character radical).

The inventory 211 includes about 3,000 frequently used Chinese characters (e.g., required by Chinese elementary school students by the time they graduate from 6th grade). The inventory 212 (also referred to as a “sightwords inventory”) includes characters that are required to be recognized by young learners (e.g., at k-2 grades) because these are the most frequently used words, also referred to as sight words. Young learners are required to know them by seeing them, though writing may not be required.

For any given character, there are two types of parsing involved at 210: morphological parsing and etymological parsing. Morphological parsing involves separating the “char body” (i.e., character body) and the “char radical” (i.e., character radical), the two basic morphological component of any given Chinese character. Etymological tagging involves identifying the “char root” and the original meaning of the given character in the oracle bone script. The term “char root” is used here to denote specifically the semantic lineage of the given character.

The result of step 210, with every character parsed into its body, radical and root, is fed into step 220, where the character is assigned one of 3 CHAR TYPE (also referred to as character types) and one of the 24 CHAR FAMILY (also referred to as character families). The three character types include: OBS character, LHF character, and UL character. In general, a character can be parsed into body and radical based on the morphology of the character. Then, semantically, the body and the radical can both be traced to the respective character root, which invariably are included in the 300 or so original oracle bone script single characters, which are all pictographs.

OBS characters include the original 300 or so singles and radicals in the Oracle Bone Script and they serve as the basic building blocks of all modern Chinese language. They are the character roots. All OBS characters are the original pictographs. LHF characters include low hanging fruit characters that are directly derived from the OBS characters, hence retaining a strong morphological or semantic tie to the originating OBS characters. A large portion of LHF characters falls into the linguistic category of indicatives. UL characters include unlocked characters that are further derived from the originating OBS characters and/or LHF characters. They are further away from the word root, yet still retaining certain degree of semantic tie to the originating OBS char. A large portion of UL characters falls into the linguistic category of semantic compound characters and phono-semantic compound characters.

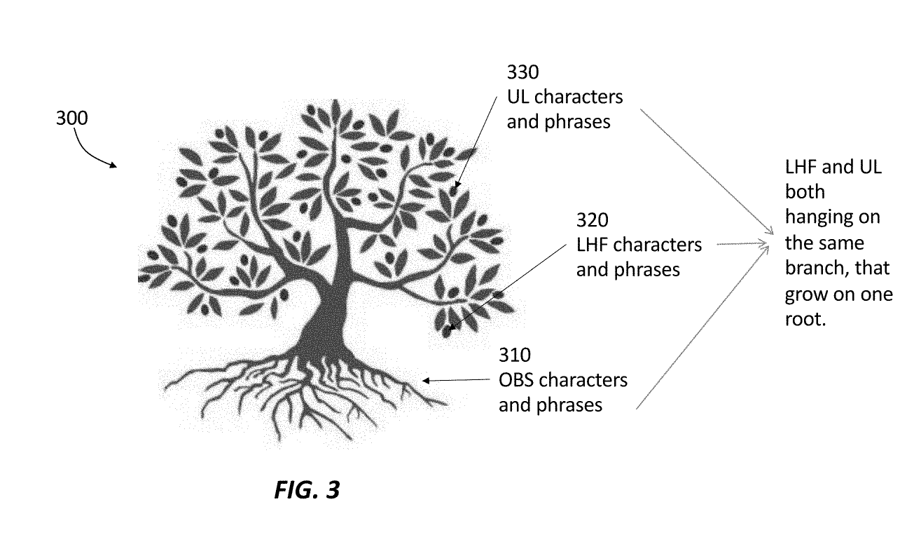

FIG. 3 shows an exemplary schematic 300 to illustrate the three types of characters, including the OBS characters 310, the LHF characters 320, and the UL characters 330. Each character type is also associated with a corresponding type of phrases. For example, the OBS characters 310 include OBS phrases, the LHF characters 320 include LHF phrases, and the UL characters 330 include UL phrases. At the roots are the original oracle bone scripts, OBC characters 310. LHF characters 320 are the low-hanging fruits that are directly hanging on the low branches above the roots. LHF characters 320 usually share the same etymological tagging with the originating OBS characters 310. UL characters 330 are the unlocked characters that grow on the tree top, far away from the root OBS characters 310, but sharing the same etymological origin with the nearest LHF characters 320.

Besides the character type, each character is be assigned to one of the 24 character families 213. Characters families 213 are categorized according to the origin of the character in the long history of human civilization and development ranging from things in nature, human bodies, plants, animals to the long evolution of human history starting from prehistoric time.

Each given character can be used to construct phrases for learners to study. In general, an OBS phrase include only characters from OBS character. An LHF phrase can include both OBS and LHF character. An UL phrase can include all three types of character.

The character type and character family of each character are fed to step 230 for character sequencing. At this step, each character is assigned a location in a study set including characters having the same character type and character family.

The characters within each study set (i.e., same character type and character family) are sequenced in the order of semantic derivation relationship between the given Chinese character and a subsequent character if there exists a direct semantic deviation from the same character root. A direct semantic derivation relationship exist if, for example, a given character A uses one of the beacons of character B in its own (A's) construction of beacons. Then, B is placed before A.

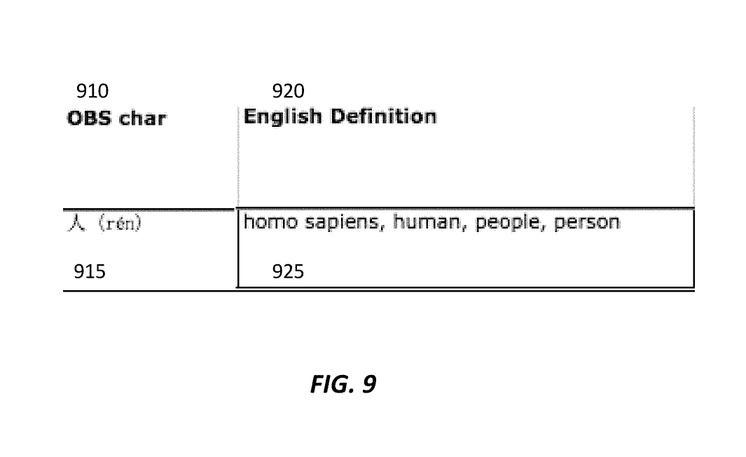

The method 200 also includes 240 for translation and beaconization. After steps 210 to 230, each character is placed in a right position (column and row) in the database. In some examples, column refers to the character type and row refers to the sequence within the character family. Conventional dictionaries usually only list the direct translations of each character or phrase in the form of semantic entries. In contrast, the English definition of a given Chinese character in the database described herein is written in a special decomposed format including the character body and the character radical. All character body and character radical have their origins in the oracle bone script, which are pictographs representing actual real-world objects. Therefore, these character body and character radicals can become the “beacon” of learning and their English and any foreign language translations become part of the beacon carrying English information to the learners. The formula for formatting the translation and beaconization is provided below with reference to FIGS. 9-12.

The method further includes, at step 250, closely following the Style Guide for the usage of space, brackets, font, and pinyin, among others. This step includes the process of formatting all data entries including the character, its pinyin (pronunciation and tone), and definition according the style guide to ensure visual uniformity and consistency.

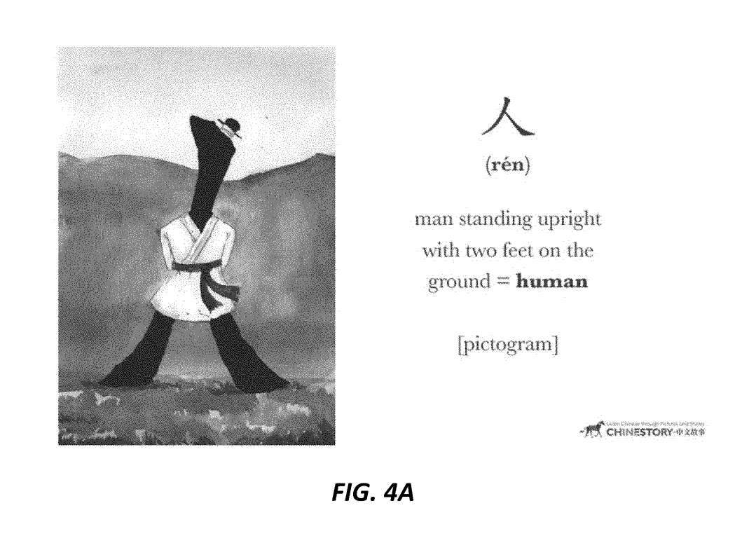

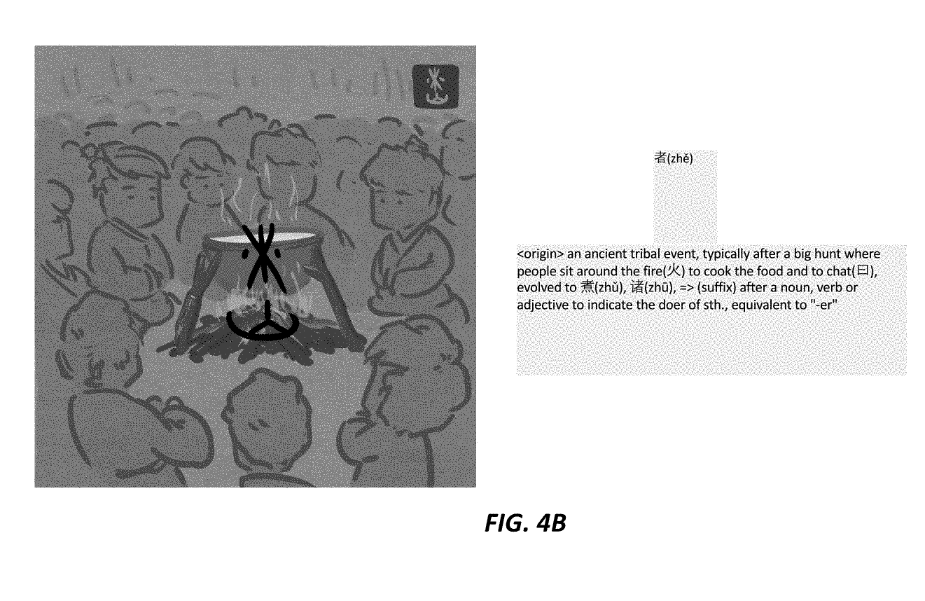

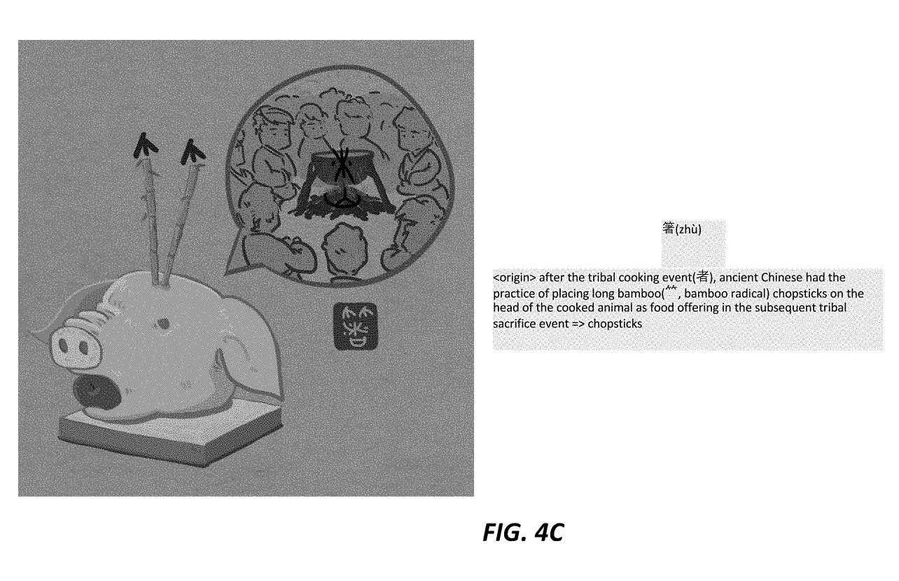

At 260, each original OBS character and semantic character is illustrated with graphs (e.g., royalty-free image). In the database, every OBS character and some LHF characters (e.g., those rich in stories) are illustrated. Because OBS characters are all pictographs, representing real-life objects, visually restoring the OBS symbol to its corresponding objects can greatly enhance learners' ability to relate to his/her real life experience. The illustration can serve as a great reminiscent tool for learners to recognize and recall the characters. For example, FIGS. 4A-4C shows exemplary graphical illustration an OBS character “human,” an LHF character “chat around bonfire,” and its derived UL character “chopsticks,” respectively.

At 270, multiple tags are created for each character based on the linguistic contexts in which the character is used. This step includes creating syntactic tagging (e.g., 160 in FIG. 1) and pragmatics tagging (e.g., 150 in FIG. 1) for each character.

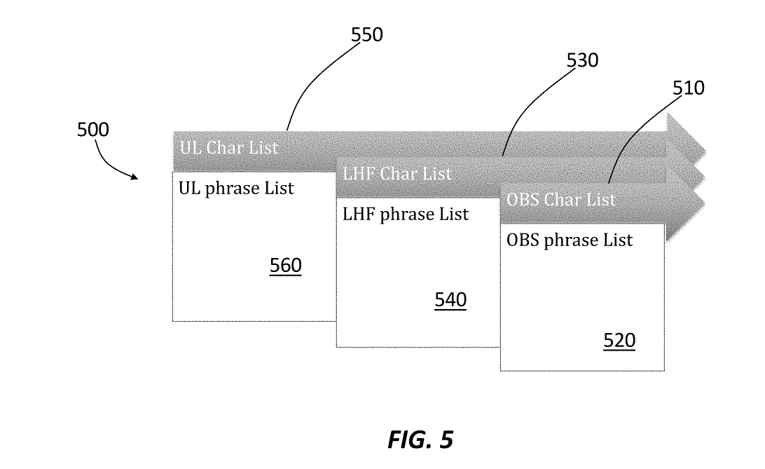

FIG. 5 illustrates an exemplary scheme 500 of study sets created for language learning, according to some embodiments of present disclosure. A study set is a vector of characters that share a common theme. Characters and phrases are organized into one or more study sets in the database, tagged by their originating family. The scheme 500 includes six study sets: an OBS character list 510, an OBS phrase list 520, an LHF character list 530, an LHF phrase list 540, an UL character list 550, and an UL phrase list 560. In some embodiments, the order these study sets 510 to 560 presented to the audience can be: 510-520-530-540-550-560. The relative size of each list is illustrated as the length of the blocked arrows.

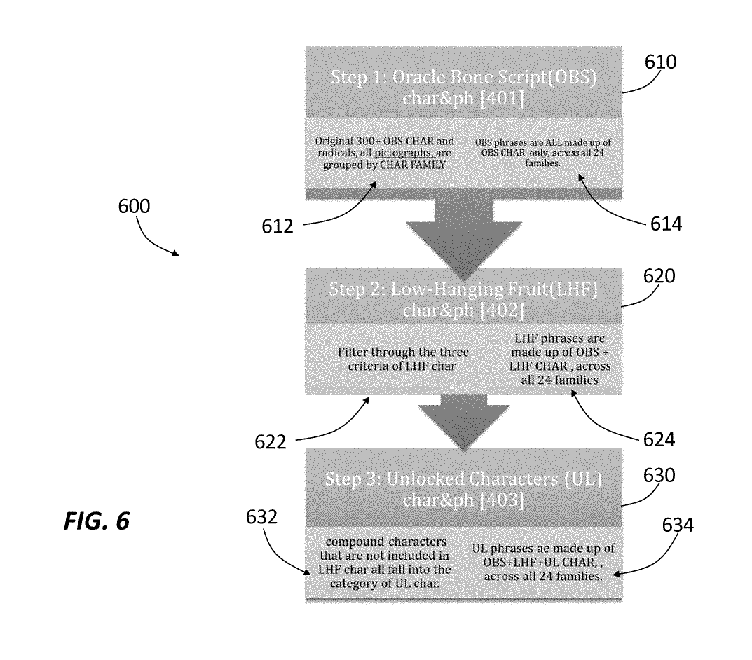

FIG. 6 illustrates an exemplary method 600 of sheet and column assignment for a given character, according to some embodiments of present disclosure. The method 600 includes three major steps 610, 620, and 630 in assigning a given character to one of the 24 character families based on its morphological tagging (e.g., 110 in FIG. 1) and etymological origin (e.g., 120 in FIG. 1) that are grouped into the 24 character families. At 610, the original 300 OBS characters (of the linguistic type pictographs) are grouped into 24 CHAR FAMILY (at 612), so are the OBS phrases that are made up of the OBS characters (at 614).

At 620, characters of the linguistics types of indicatives, semantic compounds are analyzed. Those that meet the following criteria are selected to be included in LHF characters.

Criteria 1: LHF characters have the same morphological tagging (e.g., 110 in FIG. 1) and etymological tagging (e.g., 120 in FIG. 1) as the one of the originating OBS characters.

Criteria 2: If a component of the character body (from morphological tagging 110 in FIG. 1) is the same as the originating OBS character, and the etymological tagging is also the same as the originating OBS character.

Criteria 3: If none of the above condition meets, but if the given character belongs to sight words inventory (e.g., 212 shown in FIG. 2), the character is placed under LHF without an originating OBS character. In other situations, the character is placed under UL character. In addition, LHF phrases are made up of OBS plus LHF CHAR, across all 24 families.

At 630, compound characters that are not included in LHF characters all fall into the category of UL characters. UL phrases are made up of OBS, LHF, and UL CHAR, across all 24 families.

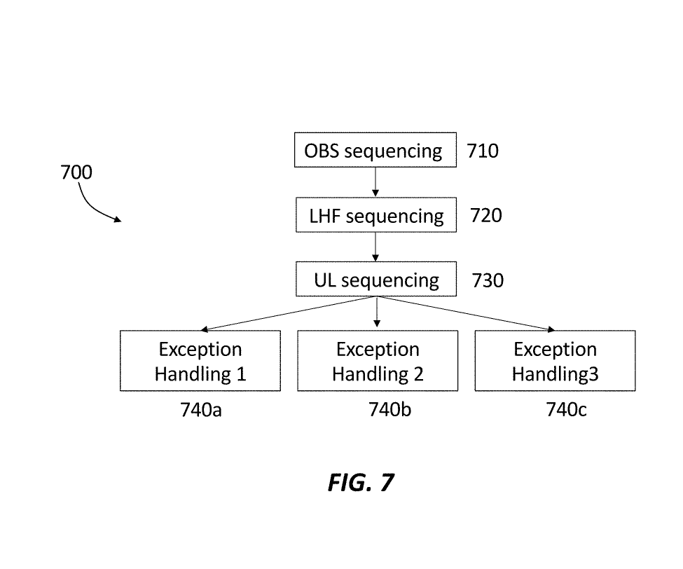

FIG. 7 illustrates an exemplary method 700 of row assignment for a given character, according some to embodiments of present disclosure. The method 700 includes OBS sequencing at 710, where OBS characters are grouped into families in the order of root reuse (the more frequent the root is used, the higher place in the sequence). For LHF sequencing at 720, the characters within each type of each character family are sequenced in the order of semantic derivation relationship between the given Chinese character and a subsequent character if there exist a direct semantic deviation from the same character root. A semantic derivation relationship exists if a given character A has a semantic tagging (e.g., 140) found in another character B, then B is placed before A in the database. UL sequencing at 730 is determined based on the order of usage frequency, i.e., more frequently used characters are placed prior to lesser used ones.

In some embodiments, the row assignment can be carried out as following: given Character A (140a, 140b . . . 140n) and Character B (140a, 140b . . . 140n), if A(004n) derives its meaning from B(004n), then place B ahead of A in the sequence.

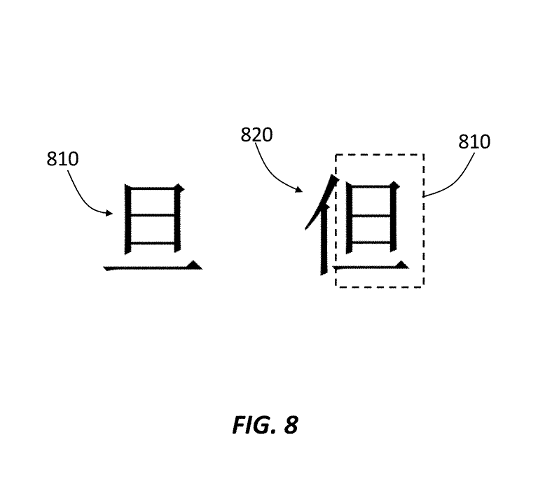

FIG. 8 illustrates an example of row assignment, according to some embodiments of present disclosure. A first character 810 (“sun rise”) is placed ahead of a second character 820 (“a new thought dawn to a person”), because the semantic tagging of the second character 820 includes the first character 810.

After considering semantic derivation relationship, Chinese character usage frequency table can be used to determine location of a given character within the vector. The method 700 also includes three exception handling 740a, 740b, and 740c.

At 740a, OBS character with “transformed to”, a special semantic tagging, and LHF character with special semantic tagging “transformed to” form a pair of semantic transformation in the history of character evolution. This pair of characters is directly placed next to each other in row. Therefore all LHF characters with “transformed from” tagging are promoted to the OBS characters, right after the corresponding OBS character with the “transformed to” tagging.

At 740b, polyphonic characters are listed as separate row entries. At 740c, characters with indirect semantic transformation, a phenomenon in Chinese linguistics, as a result of long history of character evolution, are listed as separate row entries.

FIG. 9 illustrates an exemplary method of beaconizing an OBS character, according to some embodiments of present disclosure. Specific formula is used to fashion the translation sentences that contain the beacons, which are the combination of English definition and its counterpart Chinese character. The formula is presented below:

(origin) English translation of the original meaning of the OBS character=this character's dictionary entry of that definition in English

As illustrated in FIG. 9, the OBS character 910 lists a corresponding character 915 (“human being”) in Chinese together with its pronunciation denoted by pinyin. The translation 920 includes a corresponding entry 925 containing dictionary explanations of the OBS character 915.

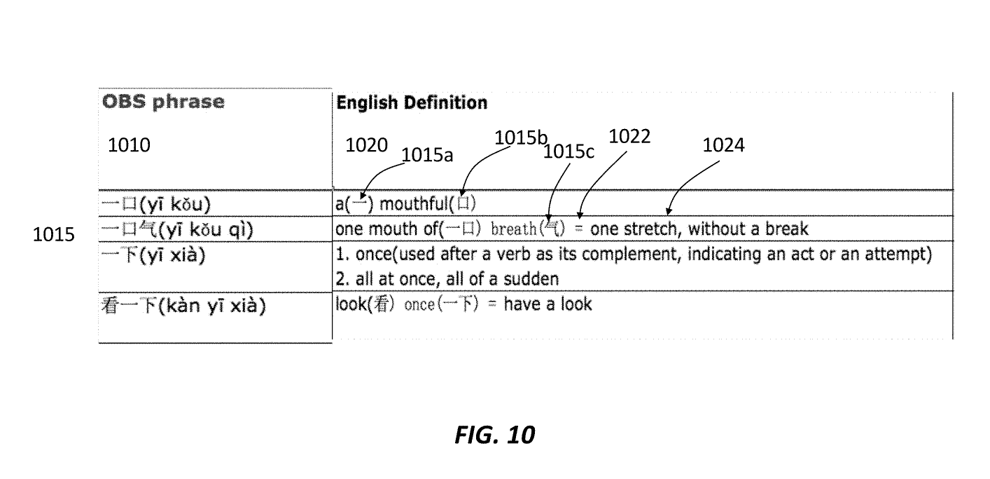

FIG. 10 illustrates an exemplary method of beaconizing an OBS phrase, according to some embodiments of present disclosure. In general, OBS phrase beaconization includes three steps. At step 1, the OBS phrase is translated into English. Step 2 includes inserting the beacon of each constituent character in the phrase into the English or any foreign language translation and placing them on the left side of an equal sign (i.e., “=”). Step 3 includes placing this phrase's dictionary entry of that definition in English to the right side of the equal sign.

As illustrated in FIG. 10, the OBS phrase includes a first phrase 1015, which in turn includes three OBS characters 1015a, 1015b, and 1015c. The first two characters 1015a and 1015b are beaconized in the first row. The second row shows the beaconization of the entire phrase 1015, including an equal sign 1022, the beacon of each character (1015a, 1015b, and 1015c) on the left side of the equal sign 1022, and the English or any foreign language translation 1024 of the entire phrase 1015 on the right side of the equal sign 1022.

The beaconization of LHF characters can include four steps. Step 1 includes using a given character's two morphological tagging (e.g., 110 in FIG. 1): character body and radical. Step 2 includes writing the translation sentence according to the original meaning of the LHF character. Step 3 includes inserting the beacon of the character body and radical of the character into the English or any foreign language translation and placing them on the left side of an equal sign. Step 4 includes placing this character's dictionary entry of that definition in English to the right side of the equal sign.

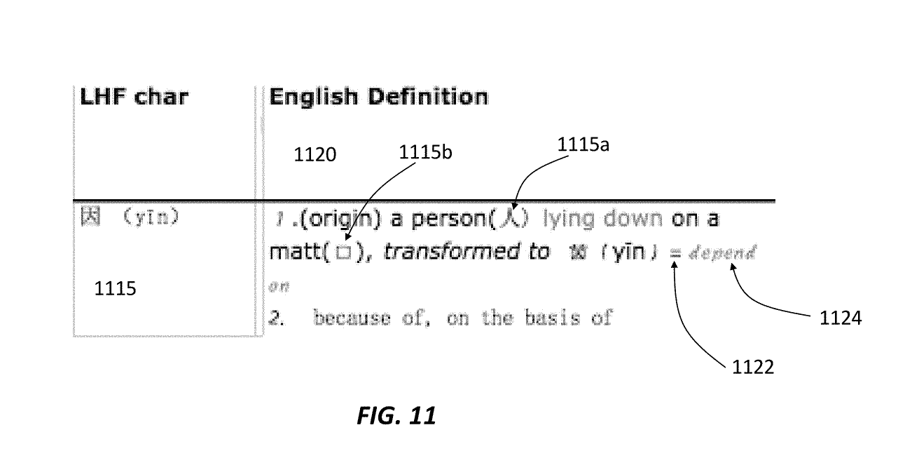

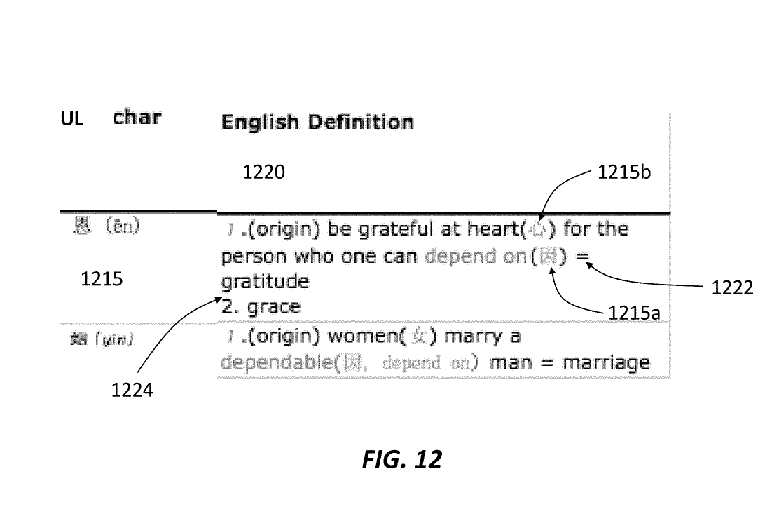

FIGS. 11 and 12 show examples of LHF character and UL character beaconization, respectively, according to some embodiments of present disclosure. In FIG. 11, the LHF character 1115 can be decomposed into a character body 1115a and a radical 1115b. The body 1115a and radical 1115b and their English translations are placed on the left side of an equal sign 1122 in a translation entry 1120. On the right side of the equal sign 1122 lists the English translation 1124 of the LHS character 1115. Similarly, in FIG. 12, the UL character 1215 can be decomposed into a character body 1215a and a radical 1215b. The body 1215a and radical 1215b and their English translations are placed on the left side of an equal sign 1222 in a translation entry 1220. On the right side of the equal sign 1122 lists the English translation 1224 of the LHS character 1215.

Sequencing the characters starting with its originating OBS beacons, subsequently enlisting characters that bear the same originating OBS beacon. Enlist compound characters according to its comprising beacon(s) in an iterative manner such that characters with two or more beacons are subsequently represented.

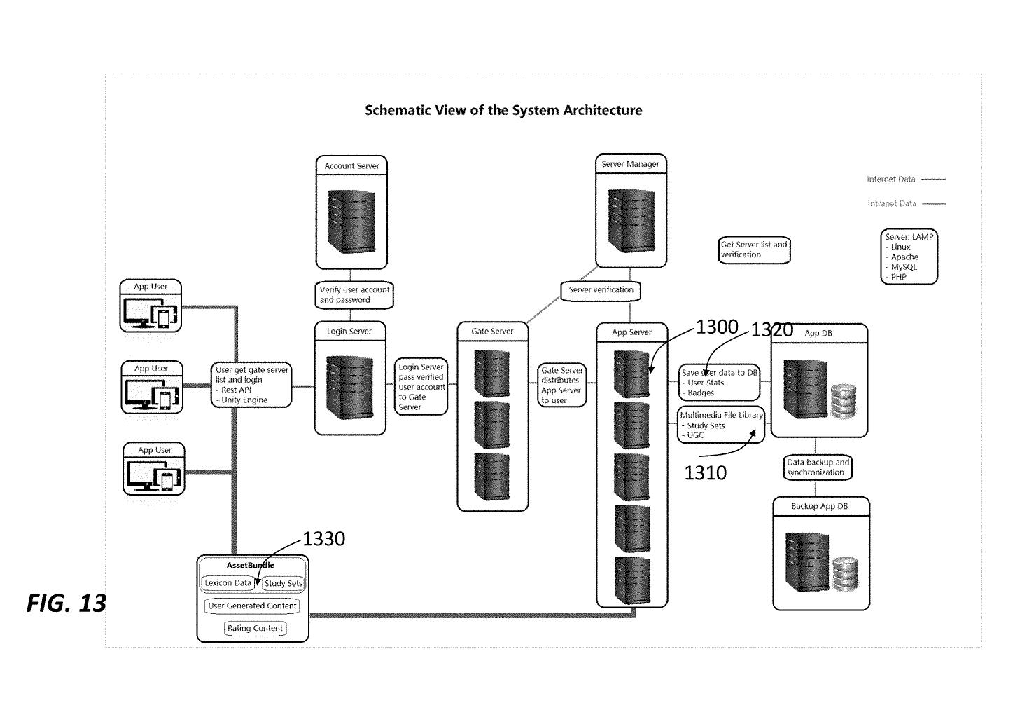

The systems and apparatus of the present disclosure can be configured as an application and platform as shown in FIG. 13 to facilitate the teaching and learning processes. The application aspect presents content and interaction to users for learning. The platform supports per-user data to allow customized learning and progress. Components in the system are described below.

Database Server (App DB): The database server can be implemented using MySQL. This database stores user accounts and user profile data 1320 associated with each account. These user data include user preferences and learning progress on every study set (or lesson). The database is accessed by the application server upon log-in to query user data for preparing the appropriate presentation to the user, and whenever the user makes learning progress.

Application Server (App Server): The application server is the central component of communication that talks to both clients and the database. It serves to shield the database server from clients so that the database is not exposed to the public network, as an added security measure. The application server accesses the database when a user logs in or creates a new account, edits preferences, or makes progress in his or her learning. The application server will be developed as a native C++ application running on machines running the Linux operating system. It communicates with clients using REST API.

Application Client (App User): The application client is where all user interaction takes place. In some embodiments, the client is an iOS mobile app developed using the Unity engine. The primary functions of the client is first querying the server for what contents are available to the user. Then, once the user chooses the desired content, the personalized study set generator 1300 processing the request, the client presents the chosen content 1330 to the user using a combination of 3D and 2D UI rendering.

AssetBundles: Due to the large volume of content data, the data is split into a number of units called AssetBundles. One AssetBundles typically contains all data and media files for a number of study sets (or lessons). AssetBundles can be downloaded to the client only when needed. At installation, only a small number of AssetBundles will be downloaded. This ensures that the client does not take up excessive storage on a user' mobile device. As the user progresses his/her learning and unlocks more contents, more AssetBundles will be downloaded.

Multimedia File Library: The present application also relates to a multimedia platform built on a beaconized database of Chinese characters 1310. One part of the platform curated all related multi-media content such as sound bite, movie clip, songs, photos, etc., that is specifically pertaining to the key learning point. The other part of the platform logs all user learning data, specific to each and every target learning point, such that system feedback is meaningful and right to the point, instead of just based on behavioral data such as number of days working in a row. Such a platform is designed to solve a major challenge faced by any foreign language instruction, which is to make repetition of the learned material with great variety such that repetition, which is necessary for memorization, becomes not mechanical but meaningful and interesting.

Subsequently, all real time user data are saved to user database. This backend linked infrastructure makes it easy to pinpoint where the learners' knowledge broke down and go back to reinforce that weak memory link or key learning point. Such data-driven learning is to fulfill the goal of personalized learning.

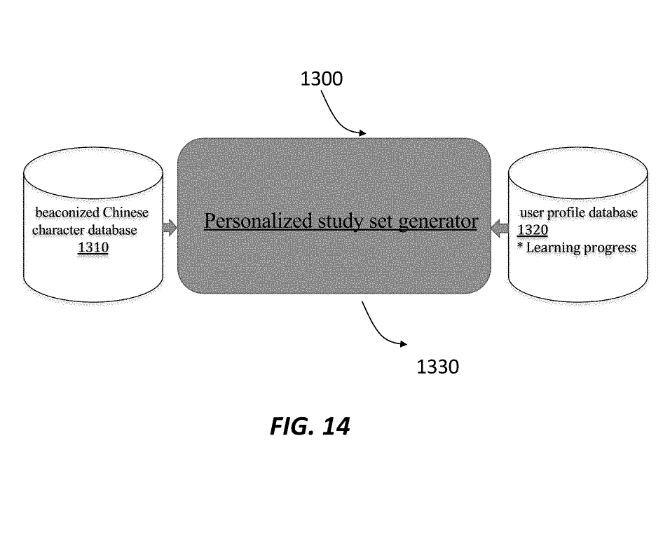

Referring to FIG. 14 a personalized study set generator 1300, is depicted for accessing both beaconized Chinese character database 1310 and user profile database 1320, generate personalized study set 1330 to be learned based on the criteria that 1) characters that contains beacons that have not been recorded in user progress can't be included in the set. 2) phrases that that contains characters that have not been recorded in user progress can't be included in the set. 3) characters with higher usage frequency get priority over characters with lower usage frequency. 4) phrases with higher usage frequency get priority over phrases with lower usage frequency. 5) characters with syntax tagging get priority over characters without syntax tagging. 6) phrases with syntax tagging get priority over phrases without syntax tagging. Presenting to the user an individualized Chinese character study set according to the user's learning readiness, as measured by his/her learning progress recorded in user profile.

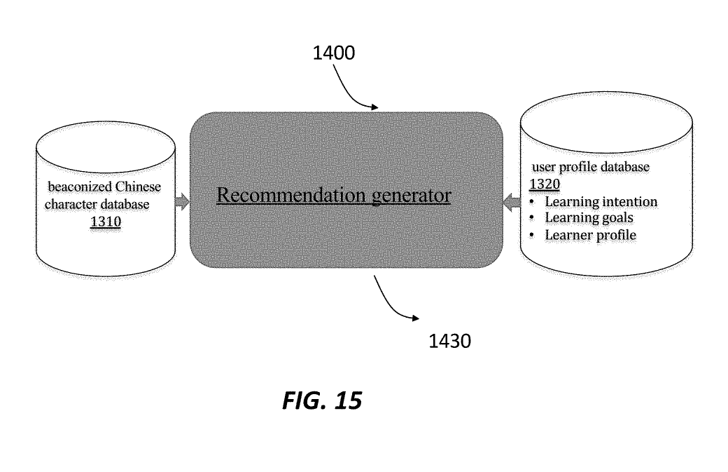

Referring to FIG. 15, a recommendation generator 1400 is depicted for accessing both beaconized Chinese character database 1310 and user profile database 1320, generates recommendations on theme-based study set 1430 to individual users based on 1) the various pragmatics tags each character or phrases bear, 2) a user's learner profile, 3) a user's learning intention, 4) a user's learning goals, 5) a user's self-specified challenge level, 6) a user's learning progress. In one of the embodiment, such recommendation could be AP I vocabulary, which consists of all characters and phrases that are preselected from the AP inventory 214, with the tag “AP I’. The recommendation is individualized filter by each user's learning progress gauged by challenge level.

Various implementations of the embodiments disclosed above, in particular at least some of the methods/processes disclosed, may be realized in digital electronic circuitry, integrated circuitry, specially designed ASICs (application specific integrated circuits), computer hardware, firmware, software/applications, databases and/or combinations thereof. These various implementations may include implementation in one or more computer programs that are executable and/or interpretable on a programmable system including at least one processor, which may be special or general purpose, coupled to receive data and instructions from, and to transmit data and instructions to, a storage system (e.g., a memory), at least one input device, and at least one output device.

Such computer programs (also known as programs, software, software applications, applications, apps, or code) include machine instructions for a processor, for example, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs), non-transitory computer program product) used to provide machine instructions and/or data to a programmable processor, including a machine-readable medium (e.g., a non-transitory computer readable medium) that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube), LCD (liquid crystal display) monitor, display, and the like) for displaying information to the user and a keyboard (screen based or hardware) and/or a pointing device (e.g., a mouse or a trackball, touchscreen) by which the user may provide input to the computer. For example, program/application embodiments of the present disclosure can be stored, executed and operated by the dispensing unit, remote control, PC, laptop, smart-phone, media player, personal data assistant (“PDA”), or other computer-processor based mobile device. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Some embodiments of the subject matter described herein may be implemented in a computing system and/or devices that includes a back-end component (e.g., as a data server), or that includes a middleware component (e.g., an application server), or that includes a front-end component (e.g., a client computer/device having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Thus, in some embodiments:
a computing system is provided, which include clients (e.g., mobile devices) and servers. A client and server are generally remote from each other and typically interact through a communication network. The relationship of client and server arises by virtue of computer programs running on the respective computers and having a client-server relationship to each other; and
at least one processor is provided (which may be in at least one of a server and one or more mobile devices) which may include instructions/code operating/operational thereon for carrying out one and/or another disclosed methods, processors, or algorithms, which may communicate with one or more databases and/or memory—of which, may store data required for different embodiments of the disclosure. As noted, the processor may include computer instructions operating thereon for accomplishing any and all of the methods, processes, and algorithms disclosed in the present disclosure. Input/output means may also be included, and can be any such input/output means known in the art (e.g., display, printer, keyboard, microphone, speaker, transceiver, and the like). Moreover, in some embodiments, the processor and at least the database can be contained in a personal computer, client computer (e.g., mobile device) which may operate and/or collect data. The processor also may communicate with other computers via a network (e.g., intranet, internet).

Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, structure, functionality, steps, processes, and configurations described herein are meant to be exemplary and that the actual parameters, dimensions, materials, structure, functionality, steps, processes, and configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the embodiments disclosed herein are presented by way of example only and that, such embodiments (and any embodiments supported by the present disclosure either expressly, implicitly or inherently) may be practiced otherwise than as specifically described and claimed. Some embodiments of the present disclosure are directed to each individual feature, system, article, material, kit, and/or method described herein, and any combination of two or more such features, systems, articles, materials, kits, and/or methods, if such features, systems, articles, materials, kits, and/or methods are not mutually inconsistent, is included within the inventive scope of the present disclosure. Additionally, some embodiments of the present disclosure are inventive over the prior art by specifically lacking one and/or another feature/functionality disclosed in such prior art (i.e., claims to such embodiments can include negative limitations to distinguish over such prior art).

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented in the present application, are herein incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A non-transitory computer readable medium having program instructions stored thereon for causing a computer to perform a method of language instruction or the method being used for the teaching for language acquisition by a user, the method, comprising:
accessing a database having a representation of a Chinese character and a morphological decomposition of the Chinese character for the purpose of language acquisition by a user, stored thereon;
accessing the database having stored thereon an etymological associations of the Chinese character with an oracle bone script symbol;
presenting to the user a representation of the Chinese character and how the Chinese character morphologically and etymologically relates to the oracle bone script symbol; and
presenting to the user the morphological decomposition of the Chinese character.

2. A non-transitory computer readable medium having program instructions stored thereon for causing a computer to perform the method of claim 1, further comprising:
presenting to the user a description containing the beacon of each of the morphological component of the Chinese character as it relates to the etymological origin to derive the modern semantics of the Chinese character.

3. A non-transitory computer readable medium having program instructions stored thereon for causing a computer to perform the method of claim 1, wherein the Chinese character is a compound character.

4. A non-transitory computer readable medium having program instructions stored thereon for causing a computer to perform the method of claim 3, further comprising:
presenting to the user at least a second oracle bone script symbol to which the compound character is etymologically associated with.

5. A non-transitory computer readable medium having program instructions stored thereon for causing a computer to perform the method of claim 4, further comprising:
presenting to the user a description of the morphological decomposition of the Chinese character and the various layers of meaning of the Chinese character from its etymological origin to various derived meanings.

6. A non-transitory computer readable medium having program instructions stored thereon for causing a computer to perform the method of claim 1, further comprising:
presenting the beacon of the Chinese character to the user.

7. A non-transitory computer readable medium having program instructions stored thereon for causing a computer to perform the method of claim 6, further comprising:
presenting to the user a phrase comprised of the Chinese character.

8. A non-transitory computer readable medium having program instructions stored thereon for causing a computer to perform the method of claim 1, further comprising:
presenting an illustration of the Chinese character with the associated oracle bone script symbol.

9. A non-transitory computer readable medium having program instructions stored thereon for causing a computer to perform the method, comprising:
accessing a database having a representation of a Chinese character to be learned by a user, stored thereon;
accessing associations of the Chinese character with an oracle bone script symbol;
presenting learning information related to the Chinese character to a user;
testing a user about their knowledge of the Chinese character;
storing a representation of the user's learning progress based on the knowledge of the Chinese character;
accessing the representation of the user's learning progress; and
providing recommendations of what the user should learn next based on the user's learning progress.

10. A non-transitory computer readable medium having program instructions stored thereon for causing a computer to perform the method of claim 9, wherein the user's knowledge is based on many Chinese characters.

11. A non-transitory computer readable medium having program instructions stored thereon for causing a computer to perform the method of claim 10, wherein the recommendations are based on Chinese characters relating to the same beacon.

12. A non-transitory computer readable medium having program instructions stored thereon for causing a computer to perform the method of claim 9, wherein recommendations are based on other Chinese characters that are related to the same oracle bone script symbol as the Chinese character.

13. A non-transitory computer readable medium having program instructions stored thereon for causing a computer to perform the method, comprising:
generating a list of Chinese characters to be learned for a user, having a user profile stored on a server computer, the generating of the list based on a set of parameters associated with the user profile, the list of Chinese characters being chosen from a database of Chinese characters;
transmitting by a server computer morphological decompositions and beacons of the Chinese characters from the list of Chinese characters;
determining the user's progress of learning the Chinese characters;
receiving by the server computer an indication of the user's progress of learning of the Chinese characters; and
updating the set of parameters associated with the user profile based on the indication of the user's progress of learning the Chinese characters.

14. A non-transitory computer readable medium having program instructions stored thereon for causing a computer to perform the method of claim 13, further comprising:
generating a new list of Chinese characters based on the updated set of parameters.

15. A non-transitory computer readable medium having program instructions stored thereon for causing a computer to perform the method of claim 14, wherein at least one of the parameters is a user learning intention parameter.

16. A non-transitory computer readable medium having program instructions stored thereon for causing a computer to perform the method of claim 15, wherein the user learning intention parameter dictates a set of Chinese characters to be learned.

17. A non-transitory computer readable medium having program instructions stored thereon for causing a computer to perform the method of claim 15, wherein the user learning intention include preparing for daily conversation.

18. A non-transitory computer readable medium having program instructions stored thereon for causing a computer to perform the method of claim 15, wherein the user learning intention include preparing for a Chinese language test.

19. A non-transitory computer readable medium having program instructions stored thereon for causing a computer to perform the method of claim 15, wherein the user learning intention include learning for early childhood language acquisition.

20. A non-transitory computer readable medium having program instructions stored thereon for causing a computer to perform the method of claim 15, wherein the user learning intention include learning for use in business.
